(19) United States
(12) Patent Application Publication
(10) Pub. No.: US 2006/0286349 A1
(43) Pub. Date: Dec. 21, 2006

(54) Multilayer, transparent polyester film with high oxygen barrier

(76) Inventors: Dagmar Klein, Ockenheim (DE); Herbert Peiffer, Mainz (DE); Gottfried Hilkert, Saulheim (DE)

Correspondence Address: PROPAT, L.L.C., 425-C SOUTH SHARON AMITY ROAD, CHARLOTTE, NC, 28211-2841, US

(21) Appl. No.: 11/451,949

(22) Filed: Jun. 13, 2006

(30) Foreign Application Priority Data
Jun. 15, 2005 (DE) 10 2005 027 657.1

(51) Int. Cl. B32B 27/36; B32B 27/20

(52) U.S. Cl. 428/141; 428/480; 428/910; 428/323; 264/173.15

(57) ABSTRACT

This invention relates to a three-layer, polyester film with A-B-C structure, which includes a base layer B, preferably formed from PET, disposed between cover layers A and C. The cover layers contain polyester with ethylene terephthalate and/or ethylene isophthalate units and, as an additional polymer poly(m-xylene-adipamide) in an amount of 10 to 45 wt. %. At least one of the cover layers also contains an antiblocking agent preferably with a mean particle diameter of 2 to 5 μm. This film has a high oxygen barrier.

### FIELD OF THE INVENTION

The invention relates to a multilayer, transparent, biaxially oriented polyester film with a base layer B and cover layers A and C applied to this base layer B on both sides. As well as polyester, the cover layers contain poly(m-xylene-adipamide) (MXD6) as an additional polymer. The invention further relates to a process for the production of the foil and the use thereof.

### BACKGROUND OF THE INVENTION

Transparent, biaxially oriented polyester films, which are characterized by improved barrier properties and contain MDX6 in at least one cover layer, are known according to the state of the technology.

In EP-A-1 440 793, a biaxially oriented polyester film is described, which has a polyester-containing base layer B and at least one cover layer A, which contains MDX6. The film is characterized by improved optical properties such as increased gloss and by good barrier properties, in particular against oxygen penetration, and is therefore suitable as packaging material for foodstuffs and semi-luxury foods/tobacco products. The film is not easily producible, in particular when the MXD6 content in the cover layer is comparatively high. Moreover, the film may then tend to delamination between the individual layers.

In EP-A-1 457 316, a multilayer, transparent, biaxially oriented polyester film with a base layer B and at least one cover layer A applied onto this base layer B is described, wherein the base layer B and the cover layer A contain MXD6. This polyester film has improved optical properties, in particular increased gloss, compared to films according to the state of the technology. In addition, the film is characterized by good barrier properties, in particular against the penetration of oxygen.

### SUMMARY OF ADVANTAGEOUS EMBODIMENTS OF THE INVENTION

The purpose of the present invention was to make available a transparent, biaxially oriented polyester film which does not have the disadvantages of the films from the state of the art and is characterized in particular by
further improved barrier properties, in particular against oxygen,
improved adhesive strength between the respective layers,
improved winding and improved processing behavior and
economical production.

It should for example be ensured that the reworked material can again be fed into the extrusion in a quantity of up to ca. 60 wt. %, without the optical properties of the film, but in particular the barrier against oxygen, being adversely affected thereby.

### BRIEF DESCRIPTION OF THE DRAWINGS

FIG. 1 is an exemplary particle size distribution summation curve illustrating d₅₀;

FIG. 2 is an exemplary particle size distribution summation curve illustrating d₁₀ and d₉₈.

### DETAILED DESCRIPTION OF ADVANTAGEOUS EMBODIMENTS OF THE INVENTION

This purpose is achieved by a three-layer, transparent, biaxially oriented polyester film with a base layer B, at least 80 wt. % of which comprises a thermoplastic polyester, and cover layers A and C applied thereon, which contain
ethylene terephthalate and/or ethylene isophthalate units in a quantity of 54 to 90 wt. % and
poly(m-xylene-adipamide) (MXD6) in a quantity of 10 to 45 wt. %, and
   wherein at least one of the cover layers A and C contains at least one antiblocking agent, which is characterized by the following features:
The mean particle diameter (d₅₀ value) lies in the range from 2 to 5 μm,
the scatter of the particle size distribution, expressed by the SPAN 98, lies in the range from 1.2 to 2.0, and
the concentration lies in the range from 0.1 to 1 wt. %.

The parameters stated above (wt. %, diameter, etc.) are preferred values. The present invention also includes embodiments outside these value ranges. Wt. % relates to the total weight of the appropriately finished layer or layers. The term polyester is also understood to mean mixtures of different polyesters.

The film according to the invention has an oxygen permeation of preferably less than 60 cm³/(m²·bar·day) and a minimum adhesion between the layers A and B of preferably greater than/equal to 1.0 N/15 mm.

The film according to the invention is preferably structured in three layers. It then consists of the cover layer A, the base layer B and the cover layer C (layer order A-B-C).

Base Layer B

Preferably at least 80 wt. % of the base layer of the film comprises a thermoplastic polyester. Polyesters from ethylene glycol and terephthalic acid (=polyethylene terephthalate, PET), from ethylene glycol and naphthalene-2,6-carboxylic acid (=polyethylene 2,6-naphthalate, PEN), from 1,4-bis-hydroxymethylcyclohexane and terephthalic acid (=poly(1,4-cyclohexanedimethylene terephthalate, PCDT), and from ethylene glycol, naphthalene-2,6-dicarboxylic acid and biphenyl-4,4′-dicarboxylic acid (=polyethylene 2,6-naphthalate bibenzoate, PENBB) are suitable for this. Polyesters in which at least 90 mol. %, preferably at least 95 mol. %, comprises ethylene glycol and terephthalic acid units or of ethylene glycol and naphthalene-2,6-dicarboxylic acid units are particularly preferable. The remaining monomer units derive from other diols or dicarboxylic acids. Suitable diol comonomers are for example diethylene glycol, triethylene glycol, aliphatic glycols of the general formula HO—(CH₂)ₙ—OH, wherein n represents a whole number from 3 to 6, branched aliphatic glycols with up to 6 carbon atoms, aromatic diols of the general formula HO—C₆H₄—X—C₆₄—OH, wherein X stands for —CH₂—, —C(CH₃)₂—, —C(CF₃)₂—, —O—, —S— or —SO₂—, or bisphenols of the general formula HO—C₆H₄—C₆H₄—OH are used.

The dicarboxylic acid comonomer units are preferably derived from benzene-dicarboxylic acids, naphthalenedicarboxylic acids, diphenylacetylene-x,x′-dicarboxylic acids (in particular diphenylacetylene-4,4′-dicarboxylic acid), cyclohexanedicarboxylic acids (in particular cyclohexane-1,4-dicarboxylic acid), stilbene-x,x′-dicarboxylic acid or (C₁-C₁₆) alkane-dicarboxylic acids, wherein the alkane part can be straight-chain or branched.

The production of the polyesters can be effected by the transesterification process. In this, the starting point is dicarboxylate esters and diols, which are reacted with the usual transesterification catalysts, such as zinc, calcium, lithium and manganese salts. The intermediate products are then polycondensed in the presence of generally usual polycondensation catalysts such as antimony trioxide or titanium salts. Their production can be effected just as well by the direct esterification process in the presence of polycondensation catalysts. In this, the starting point is the dicarboxylic acids and the diols.

Cover Layers A and C

The cover layers A and C contain ethylene terephthalate and/or ethylene isophthalate units in a quantity of preferably 54 to 90 wt. %. In particular, they contain these starting materials in a quantity of 56 to 89 wt. %, and particularly preferably in a quantity of 59 to 88 wt. %. In principle, for both cover layers A and C, the same (polyester) polymers can be used as for the base layer B, in particular however polyethylene terephthalate. The cover layers A and C can be the same or different.

It is particularly advantageous when a polyester copolymer based on isophthalic acid and terephthalic acid is used in the cover layers A and C. In this case the optical properties of the film are particularly good.

In this case, the cover layers A and C essentially contain one polyester copolymer, which is predominantly made up of isophthalic acid and terephthalic acid units and of ethylene glycol units. The remaining monomer units derive from other aliphatic, cycloaliphatic or aromatic diols or dicarboxylic acids, such as can also be present in the base layer. The preferred copolyesters, which provide the desired properties of the film, are those which are built up of terephthalate and isophthalate units and of ethylene glycol units. The content of ethylene terephthalate is 60 to 97 mol. % and the corresponding content of ethylene isophthalate 40 to 3 mol. %. Copolymers wherein the content of ethylene terephthalate is 70 to 95 mol. % and the corresponding content of ethylene isophthalate is 30 to 5 mol. % are preferred.

According to the invention, both cover layers A and C contain as a further component poly(m-xylene-adipamide) (MXD6) in a quantity of preferably 10 to 45 wt. %, in particular in a quantity of 11 to 43 wt. %, and particularly preferably in a quantity of 12 to 40 wt. %, based on the weight of the cover layers A and C.

If the content of MXD6 in the two cover layers A and C is less than 10 wt. %, the barrier action of the film may no longer be sufficient, and if the content of MXD6 in the two cover layers A and C is greater than 45 wt. %, the adhesive strength between individual layers may be insufficient, and the film delaminates.

Poly(m-xylene-adipamide) (MXD6), also described as poly-m-xylylene-adipamide or PA-MXD6, is a polycondensation product (polyarylamide) from m-xylylenediamine and adipic acid and is offered on the market as various types, which are in principle all suitable for the purpose according to the invention. Types with a melt viscosity of less than 8000 poise (at 260° C.) are preferable.

The thickness of the two cover layers A and C is preferably greater than 0.9 μm and lies in particular in the range from 1.0 to 10 μm and particularly preferably in the range from 1.1 to 5 μm.

The base layer B and the two cover layers A and C can in addition contain normal additives, such as for example stabilizers. At least one of the two cover layers A and C is also provided with an antiblocking agent. The additives are advantageously already added to the polymer or the polymer mixture before melting. As stabilizers, for example phosphorus compounds, such as phosphoric acid or phosphate esters, are used.

Typical antiblocking agents (in this context also described as pigments) are inorganic and/or organic particles, for example calcium carbonate, amorphous silicic acid, talc, magnesium carbonate, barium carbonate, calcium sulfate, barium sulfate, lithium phosphate, calcium phosphate, magnesium phosphate, aluminum oxide, lithium fluoride, calcium, barium, zinc or manganese salts of the dicarboxylic acids used, carbon black, titanium dioxide, kaolin or cross-linked polystyrene or acrylate particles.

As additives, mixtures of two or more different antiblocking agents or mixtures of antiblocking agents of the same composition, but different particle size, can be selected. The particles can be added to the relevant layers in the concentrations intended for this, e.g. as a glycol dispersion during the polycondensation or via master batches during the extrusion.

To achieve good winding and good processability for the film, it has been found advantageous for this to contain a pigment system (antiblocking agent), wherein the mean diameters (d₅₀ value) lie in the range from 2.0 to 5.0 μm and the SPAN 98 in the range of 1.2 and 2.0, in at least one of the two cover layers A and C.

In a preferred embodiment, at least one of the two cover layers A and C contains a pigment system wherein the mean particle diameter lies in the range from 2.1 to 4.9 μm and the SPAN 98 in the range of 1.25 and 1.9. In a particularly preferred embodiment, at least one of the two cover layers A and C contains a pigment system wherein the mean particle diameter lies in the range from 2.2 to 4.8 μm and the SPAN 98 in the range of 1.3 and 1.8.

At least one of the two cover layers A and C is comparatively highly filled with inert pigments to improve the winding behavior and processability. The concentration of the inert particles in one of the aforesaid cover layers preferably lies between 0.10 and 1.0 wt. %, in particular between 0.13 and 0.9 wt. % and in the particularly preferred embodiment between 0.16 and 0.8 wt. % and is essentially defined on the basis of the optical properties of the film to be achieved.

The roughness Rₐ of the antiblocking agent-containing cover layer is preferably greater than 40 nm. In a preferred embodiment, the roughness Rₐ is more than 45 nm and in a particularly preferred embodiment the roughness Rₐ is more than 50 nm.

In a further preferred embodiment of the invention, the other of the two cover layers A and C also contains antiblocking agents. In principle here, the two cover layers can contain different antiblocking agents in different concentrations. If the other cover layer is also filled with pigments, the same pigments are advantageously used there as was previously described in more detail for the cover layer according to the present invention.

In a further preferred embodiment of the invention, both cover layers A and C contain the same antiblocking agents at the same concentration. As a result of this, the film acquires especially good winding behavior and can be further processed without any problems.

In another, likewise advantageous, embodiment of the invention, the filler content of the other of the cover layers A and C is less than 0.1 wt. %, preferably less than 0.05 wt. %, and particularly preferably this cover layer is free from external fillers/pigments. The roughness Rₐ of this film surface is then less than 50 nm. In a preferred embodiment, the roughness Rₐ of this film surface is less than 45 nm and in a particularly preferred embodiment the roughness Rₐ of this film surface is less than 40 nm.

The gloss of this film surface is preferably greater than 120. In particular, the gloss of this side is more than 125 and in a particularly preferred embodiment more than 135.

This film surface is therefore particularly suitable for a further functional coating, for printing or for metallization. The high gloss of the film is thus passed on to the print or the applied metal layer and thereby confers on the film the (desired) attractive appearance.

The total thickness of the polyester film according to the invention is preferably 6 to 300 μm, preferably 8 to 200 μm, particularly preferably 10 to 100 μm, wherein the base layer (B) is in a proportion preferably 40 to 99% of the total thickness.

Process

Also an object of the invention is a process for the production of the film. For the production of the base layer B, the polyester granulate is preferably fed directly into the extruder for the base layer B. The polyester granulate can be extruded at about 270 to 300° C.

The polymers for the cover layers A and C are advantageously fed into the coextrusion system via respective further extruders (in principle here, the twin-screw extruder is to be preferred to the single-screw extruder). Since MXD6 does not withstand more than 275° C., the two coextruders are not operated hotter than 275° C. The melts are formed into flat melt films in a multilayer nozzle and layered one over another. Next the multilayer film is drawn off and solidified by means of a cooling roller and optionally further rollers.

The biaxial stretching is generally performed sequentially. In this, the stretching is preferably performed first in the longitudinal direction (i.e. in the machine direction) and then in the transverse direction (i.e. perpendicular to the machine direction). The stretching in the longitudinal direction can be performed by means of two rollers rotating at different speeds correspondingly to the desired stretching ratio. For the transverse stretching, an appropriate clip frame is used.

The temperature at which the stretching is performed can vary over a relatively large range and is defined on the basis of the desired properties of the film. In general, the stretching is performed in the longitudinal direction in a temperature range of 80 (heating temperatures 80 to 130° C.) to 130° C. (stretching temperatures 80 to 130° C., depending on the stretching ratio) and the transverse stretching in a temperature range of 90 (start of stretching) to 140° C. (end of stretching). The longitudinal stretching ratio preferably lies in the range from 2.0:1 to 5.0:1, in particular from 2.3:1 to 4.8:1. The transverse stretching ratio generally lies in the range from 2.5:1 to 5.0:1, preferably from 2.7:1 to 4.5:1.

Before the transverse stretching, one or both surfaces of the film can be coated in-line in accordance with the known processes. The in-line coating can for example lead to improved adhesion of a metal layer or a printing ink that may be applied, but also to the improvement of the antistatic behavior, the processing behavior, but also to the further improvement of the barrier (through application of barrier coatings, which for example contain EVOH, PVOH or the like). Preferably, such layers are then applied onto the smoother (=less rough) surface of the film.

In the subsequent thermosetting, the film is kept at a temperature of 150 to 250° C. for a period of about 0.1 to 10 secs. Next the film is wound in a usual manner.

In the production of the film, it is ensured that cuttings material which inherently arises during the operation of film production, can be used again as recycle material in a quantity of up to 60 wt. %, preferably 10 to 50 wt. %, each based on the total weight of the film, for the film production process, without the physical properties of the film being significantly adversely affected thereby.

The film according to the invention is outstandingly suitable for metallization or vacuum coating with ceramic substances. It is then quite particularly characterized by outstanding barrier properties, in particular against oxygen. The film is particularly suitable as packaging material for foodstuffs and semi-luxury foods/tobacco products.

The following table (Table 1) once again summarizes the most important properties of the film.

TABLE 1

| | | | | |
|---|---|---|---|---|
| | particularly | very particularly | | Measurement |
| preferred | preferred | preferred | Unit | method |

Cover layers A and C

| | | | | |
|---|---|---|---|---|
| Ethylene terephthalate/isophthalate units | 54 to 90 | 56 to 89 | 59 to 88 | wt. % |
| Poly(m-xylene-adipamide) (MXD6) | 10 to 45 | 11 to 43 | 12 to 40 | wt. % |
| Thickness of the cover layers A and C | >0.9 | 1.0 to 10 | 1.1 to 5 | μm |

Antiblocking agent-containing cover layer(s)

| | | | | | |
|---|---|---|---|---|---|
| Filler concentration of pigment system | 0.10 to 1.0 | 0.13 to 0.9 | 0.16 to 0.8 | wt. % | |
| Particle diameter d₅₀ of pigment system | 2.0 to 5 | 2.1 to 4.9 | 2.2 to 4.8 | μm | |
| SPAN 98 of pigment system | 1.2 to 2.0 | 1.25 to 1.9 | 1.3 to 1.8 | | |
| Roughness Rₐ of the cover layer(s) containing | >40 | >45 | >50 | nm | DIN 4768 |
| the antiblocking agent | | | | | |

Film properties

| | | | | |
|---|---|---|---|---|
| Oxygen permeation (OTR) | <60 | <58 | <56 | cm³/m² · bar · day |
| Adhesion between the layers | 1.0 to 10 | 1.2 to 10 | 1.5 to 10 | N/15 mm |

Measurement Methods

For the characterization of the starting materials and the films, the following methods were used:
DIN=German Institute for Standardization
ASTM=American Society for Testing and Materials
   (1) Oxygen Permeability (OTR=Oxygen Transmission Rate)

The measurement of the oxygen barrier was performed with an OXTRAN® 100 from Mocon Modern Controls (US) in accordance with DIN 53 380, part 3 (23° C., 50% relative atmospheric humidity on both sides of the film). Also, the measurement of the OTR was performed on 12 μm film each time.

(2) Haze

The haze of the film was determined on the basis of ASTM-D 1003-52.

(3) SV Value (Standard Viscosity)

The standard viscosity SV (DCA) is measured in dichloroacetic acid, on the basis of DIN 53726. The intrinsic viscosity IV (DCA) is calculated from the standard viscosity SV (DCA) as follows:
IV=[η]=6.907·10⁻⁴·SV (DCA)+0.063096 [dl/g]
(4) Gloss

The gloss was determined in accordance with DIN 67530. The reflector value was measured as an optical characteristic for the surface of a film. On the basis of the standards ASTM-D 523-78 and ISO 2813, the angle of incidence was set at 20°. A light beam impinges on the flat test surface at the set angle of incidence and is reflected and scattered by this. The light beams incident on the photoelectric receivers are displayed as proportional electrical values. The measured value is dimensionless and must be quoted with the angle of incidence.

(5) Roughness

The roughness Rₐ of the film was determined in accordance with DIN 4768 with a cut-off of 0.25 mm. For this, the measurement was performed not on a glass plate, but in the ring. In the ring method, the film is mounted in a ring so that neither of the two surfaces touches a third surface (e.g. glass).

(6) Mean Particle Diameter d₅₀

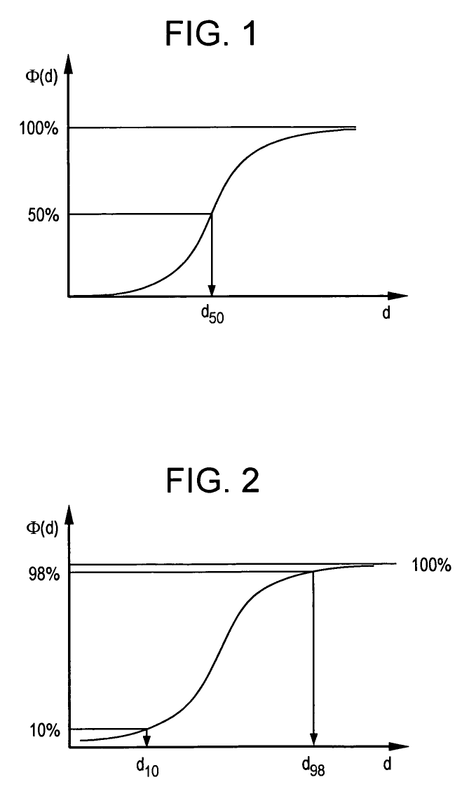

The determination of the mean particle diameter d₅₀ was performed by laser on a Malvern Master Sizer (Malvern Instruments GmbH, Germany) by the standard method (other measuring instruments are for example Horiba LA 500 from the Horiba company, Japan or Sympathec Helos from Sympathec GmbH, Germany, which use the same measurement principle). For this, the samples are placed in a cell with water and this is then placed in the measuring instrument. The measurement procedure is automatic and also includes the mathematical determination of the d₅₀ value. The d₅₀ value here is by definition determined from the (relative) summation curve of the particle size distribution: the intersection point of the 50% ordinate value with the summation curve provides the desired d₅₀ value on the abscissa axis (see FIG. 1).

(7) Measurement of the SPAN 98

The determination of the SPAN 98 was performed with the same measuring instrument as described in the determination of the mean diameter d₅₀. The SPAN 98 here is defined as follows:

$$SPAN 98 = \frac{{ⅆ}_{98} - {ⅆ}_{10}}{{ⅆ}_{50}}$$

The determination of d₉₈ and d₁₀, is again based on the summation curve of the particle size distribution. The intersection point of the 98% ordinate value with the summation curve provides the desired d₉₈ value on the abscissa axis and the intersection point of the 10% ordinate value with the summation curve provides the desired d₁₀ value on the abscissa axis (see FIG. 2).

(8) Adhesion Between the Layers

Before gluing, the film sample (300 mm long·180 mm across) is laid on smooth cardboard (200 mm long·180 mm across; ca 400 g/m², bleached, outer layers coated), the resulting film ends must be folded onto the back and fixed with adhesive tape.

The gluing of the foil according to the present invention with a standard polyester film of 12 μm thickness is effected with a blade coating device and blade coating rod No. 3 from the Erichsen company, Germany, during which ca. 1.5 ml of adhesive (NOVACOTE® NC275+CA 12; mixing ratio 4/1+7 parts ethyl acetate) is applied on the cover layer A of the film according to the present invention. After the evaporation of the solvent, the standard polyester film is laminated with a metal roller (width 200 mm, diameter 90 mm, mass 10 kg, as per DIN EN 20 535) onto the cover layer A of the film according to the present invention. The lamination parameters are:

| | |
|---|---|
| Quantity of adhesive | 5 ± 1 g/m² |
| Ventilation after application of the glue | 4 mins ± 15 secs |
| Blade-coating thickness (Erichsen) | 3 |
| Speed of coating blade | ca. 133 mm/sec |
| Cure time of the bond | 2 hrs at 70° C. |
| | in a forced air oven |

Ca. 100 mm long samples were taken with a 20±1 mm strip cutter. In this, ca. 50 mm bond and 50 mm unglued individual layers for fixing/mounting of the test piece are necessary. The test pieces should be fixed with double-sided adhesive tape with the back of the film in all-over contact with a support plate. The plate with the glued-on bond should be fixed on a peel tester. The non-laminated end of the standard polyester film should be mounted in the clip of the peel tester (e.g. Instron, Zwick company, Germany) such as to give a peeling angle of 180°. The mean peel force is stated in N/15 mm rounded to one place after the decimal point.

| | | |
|---|---|---|
| Sample width | 20 | mm |
| Measurement length | 25 | mm |
| Draw speed until initial force | 25 | mm/min |
| Run-up | 5 | mm |
| Test path | 40 | mm |
| Sensitivity | 0.01 | N |
| Draw rate | 100 | mm/min |

The measurement result for the peel strength should be equated with the minimum adhesion strength between the layers, since the adhesion strength between the adhesive and the standard film is markedly greater.

### EXAMPLES

The following examples illustrate the invention. The products used (brands and producing firm) are only stated once and then also apply to the following examples.

Chips of polyethylene terephthalate and MXD6 in a mixing ratio of 65/35 were fed directly into the extruders (=twin-screw extruder with degassing) for the two cover layers A and C. In addition, chips of polyethylene terephthalate and antiblocking agent were fed into the extruder for the cover layer C. In both extruders, the materials were extruded at a temperature of about 275° C. The melt was filtered, formed into a flat film in a multilayer nozzle and laid over the base layer B as cover layers A and C.

Chips of polyethylene terephthalate were dried at a temperature of 160° C. to a residual moisture content of less than 100 ppm and fed into the extruder for the base layer B.

By coextrusion and subsequent stepwise orientation in the longitudinal and transverse direction, a transparent, three-layer film ABC with a total thickness of 12 μm was produced. The cover layers A and C each had a thickness of 1.3 μm.

### Example 1 (E1)

Cover Layer A

35 wt. % poly(m-xylene-adipamide) (MXD6) from Mitsubishi Gas Chemical Co., product name NYLON® MXD6 6007,
65 wt. % polyethylene terephthalate (4023 from Invista/Offenbach) with an SV value of 800
   Base Layer B
100 wt. % polyethylene terephthalate (4023 from Invista/Offenbach) with an SV value of 800 and
   Cover Layer C
35 wt. % poly(m-xylene-adipamide) (MXD6) from Mitsubishi Gas Chemical Co., product name NYLON® MXD6 6007,
45 wt. % polyethylene terephthalate with an SV value of 800
20 wt. % master batch of 97.75 wt. % polyethylene terephthalate (SV value of 800) and 1.0 wt. % Sylobloc 44 H (synthetic SiO₂ from Grace Co.; particle diameter d₅₀: 2.5 μm, SPAN 98: 1.8) and 1.25 wt. % AEROSIL® TT 600 (synthetic pyrogenic SiO₂ from Degussa Co., primary grain diameter: 40 nm).

The production conditions in the individual process steps were:

| | |
|---|---|
| Extrusion | Temperatures |

| | | |
|---|---|---|
| | A-layer: | 275° C. |
| | B-layer: | 290° C. |
| | C-layer: | 275° C. |
| | Temperature of drawing roller | 25° C. |
| Longitudinal stretching | Stretching temperature: | 115° C. |
| | Longitudinal stretch ratio: | 4.0 |
| Transverse stretching | Stretching temperature: | 125° C. |
| | Transverse stretch ratio: | 3.9 |
| Fixing | Temperature | 230° C. |
| | Duration | 3 secs |

The film had the required oxygen barrier properties and the required mutual adhesion of the layers.

### Example 2 (E2)

As in Example 1, a three-layer film ABC with a total thickness of 12μ was produced by coextrusion. The cover layers A and C had a thickness of 1.8 μm each.

### Comparison Example (CE1)

A film corresponding to Example 1 of EP-A-1 440 793 was produced. The roughness values of this film are too high, and the adhesion between the layers too low.

The properties and the structure of the films produced according to the examples and the comparison example are summarized in Table 2.

TABLE 2

| | | | | | | | Adhesion | Roughness of | | | | | |
|---|---|---|---|---|---|---|---|---|---|---|---|---|---|
| | Film | | Layer thicknesses | | | | between | Side | Side | Gloss | | | |
| | thickness | Film | in μm | | | Oxygen permeation | the layers | A | C | Side | Side | Winding | Processing |
| | in μm | structure | A | B | C | cm³/m² · bar · day | N/15 mm | nm | nm | A | C | behavior | behavior |
| E1 | 12 | ABC | 1.3 | 9.4 | 1.3 | 35 | 1.8 | 27 | 63 | 134 | 128 | ++++ | ++++ |
| E2 | 12 | ABC | 1.8 | 8.4 | 1.8 | 30 | 2 | 30 | 67 | 138 | 130 | ++++ | ++++ |

| | | | | | | | | | | |
|---|---|---|---|---|---|---|---|---|---|---|
| | | | | | | | Side B | Side B | | |
| CE1 | 12 | AB | 2 | 10 | 40 | 0.6 | 70 | 130 | ++ | + |

Key to symbols for winding and processing behavior of the films:
++++ no tendency to adhesion to rollers or other mechanical parts, no blocking problems during winding and during processing in packaging machines, low production costs
+ moderate production costs
− tendency to adhesion to rollers or other mechanical parts, blocking problems during winding and during processing in packaging machines, high production costs owing to expensive handling of the film in the machines.

1. A biaxially oriented polyester film comprising a base layer B and cover layers A and C disposed thereon, said cover layers A and C comprising polyester with (i) ethylene terephthalate and/or ethylene isophthalate units and (ii) poly(m-xylene-adipamide), at least one of the cover layers further comprising at least one antiblocking agent.

2. The polyester film as claimed in claim 1, wherein at least 80 weight % of the base layer B comprises thermoplastic polyester.

3. The polyester film as claimed in claim 1, wherein the cover layers A and C comprise 54 to 90 weight % of ethylene terephthalate and/or ethylene isophthalate units.

4. The polyester film as claimed in claim 1, wherein the cover layers A and C comprise 10 to 45 weight % of poly(m-xylene-adipamide).

5. The polyester film as claimed in claim 1, wherein at least one of the cover layers A and C comprises at least one antiblocking agent having the following parameters:
a) the mean particle diameter is 2 to 5 μm,
b) the scatter of the particle size distribution, SPAN 98, is 1.2 to 2.0, and
c) the concentration is 0.1 to 1 wt. %.

6. The polyester film as claimed in claim 1, wherein the thermoplastic polyester of the base layer B has ethylene glycol and terephthalic acid units or ethylene glycol and naphthalene-2,6-dicarboxylic acid units.

7. The polyester film as claimed in claim 2, wherein polyethylene terephthalate is used as the thermoplastic polyester of the base layer B.

8. The polyester film as claimed in claim 1, wherein a polyester copolymer based on terephthalic acid and isophthalic acid is used as the polyester for the cover layers A and C.

9. The polyester film as claimed in claim 1, wherein a copolyester comprising terephthalate, isophthalate and ethylene glycol units is used as the polyester for the cover layers A and C.

10. The polyester film as claimed in claim 1, wherein the film has an oxygen transmittance (OTR) of less than 60 cm³/m²·bar·day.

11. The polyester film as claimed in claim 1, wherein the film has an adhesion between the layers A and B of greater than/equal to 1 N/15 mm.

12. The polyester film as claimed in claim 1, wherein the roughness of the cover layer containing the antiblocking agent is greater than 40 nm.

13. The polyester film as claimed in claim 1, wherein the antiblocking agent is present in a single cover layer and the gloss of the antiblocking agent-free cover layer is greater than 120.

14. A process for the production of polyester film as claimed in claim 1, said process comprising
a) producing a film by coextrusion,
b) biaxially stretching the coextruded film and
c) thermally fixing the biaxially stretched film.

15. Packaging material for foodstuffs and semi-luxury foods/tobacco products comprising polyester film as claimed in claim 1.
